(19) United States
(12) Patent Application Publication
(10) Pub. No.: US 2008/0087593 A1
(43) Pub. Date: Apr. 17, 2008

(54) Heatable and Coolable Filter Plate

(75) Inventor: Manfred Hermann, Nurnberg (DE)

Correspondence Address: LERNER GREENBERG STEMER LLP, P O BOX 2480, HOLLYWOOD, FL, 33022-2480, US

(73) Assignee: JVK FILTRATION SYSTEMS GMBH, Georgensgmund (DE)

(21) Appl. No.: 11/875,991

(22) Filed: Oct. 22, 2007

Related U.S. Application Data
(63) Continuation of application No. PCT/EP2006/003615, filed on Apr. 20, 2006.

(30) Foreign Application Priority Data
Apr. 22, 2005 (DE) DE202005006482.3

(51) Int. Cl. B01D 25/164

(52) U.S. Cl. 210/228

(57) ABSTRACT

A combined chamber and membrane filter plate includes a plate body, a plate edge being thicker than the plate body, projecting beyond the plate body and framing the plate body, a chamber side configured to form a filter chamber and a membrane side having a membrane adapted to and spaced from the plate body. The plate body has a plate surface facing the membrane and a multiplicity of parallel recesses implemented as grooves in the plate surface. The grooves decrease the thickness of the plate body and are configured to form a fluted plate surface.

### CROSS-REFERENCE TO RELATED APPLICATIONS

This is a continuing application, under 35 U.S.C. § 120, of copending International Application No. PCT/EP2006/003615, filed Apr. 20, 2006, which designated the United States; this application also claims the priority, under 35 U.S.C. § 119, of German Patent Application DE 20 2005 006 482.3, filed Apr. 22, 2005; the prior applications are herewith incorporated by reference in their entirety.

### BACKGROUND OF THE INVENTION

Field of the Invention

The invention relates to a heatable filter plate, namely a combined chamber and membrane filter plate. Such combined chamber and membrane filter plates have one plate side provided as a customary chamber filter plate and the other plate side provided as a membrane filter plate with a membrane attached in front of the chamber filter plate. When a filter packet is assembled using those types of combined chamber and membrane filter plates, one plate side with a membrane and one plate side without a membrane are always situated side by side.

The same effect can be achieved with a filter packet assembled by using chamber plates and membrane plates in an alternating pattern. With filter packets of that type having alternating plates, a chamber filter plate without a membrane is always disposed adjacent a membrane filter plate which has a membrane on both of its sides. In that way, filter chambers that are adjacent one another are again created in the filter packet, each of which has a membrane for ejecting a filter cake after a filtering process.

Finally, the process of heating the filter chambers is known from the prior art. In order to achieve that, a heated fluid, such as hot water or steam, is pumped into a space that lies behind the membrane from the filter chamber. The high temperature then diffuses through the membrane into an actual compression chamber. However, because the heating occurs from only one side of the filter chamber, namely from the membrane side, a high temperature gradient is present within the filter chamber. When alternating chamber filter plates on one side and membrane filter plates on the other side are used, that causes the heating of the filter chamber in the region of the chamber filter plate to be viewed as insufficient.

A combined chamber and membrane filter plate for a filter press is known from French Patent Application FR 2 754 758 A, corresponding to Canadian Patent Application CA 2 268 798 A1. The plate includes a plate body and a plate edge that surrounds the plate body, is thicker than it and projects beyond it, with a chamber side configured to form a filter chamber and a membrane side. The membrane side has a membrane that is disposed so as to be spaced from the plate body and the plate has a multiplicity of recesses which are grouped in multiple rings, disposed concentrically in relation to the plate center.

### BRIEF SUMMARY OF THE INVENTION

It is accordingly an object of the invention to provide a heatable and coolable filter plate, which overcomes the hereinafore-mentioned disadvantages of the heretofore-known devices of this general type and which is improved in terms of its internal heat transfer.

With the foregoing and other objects in view there is provided, in accordance with the invention, a combined chamber and membrane filter plate. The combined chamber and membrane filter plate comprises a plate body, a plate edge being thicker than the plate body, projecting beyond the plate body and framing the plate body, a chamber side configured to form a filter chamber, and a membrane side having a membrane adapted to and spaced from the plate body. The plate body has a plate surface facing the membrane and a multiplicity of parallel recesses implemented as grooves in the plate surface. The grooves decrease a thickness of the plate body and are configured to form a fluted plate surface.

Therefore, in order to attain the object of the invention, the plate body of the combined chamber and membrane filter plate has at least one recessed area that decreases the thickness of the plate body. Due to the decreased thickness of the plate body created by the shaping of the recessed area, a temperature transfer can take place from the heated fluid through the plate body to the chamber side of the combined filter plate. Advantageously, the recessed area is a multiplicity of recesses formed in the chamber filter plate. Advantageously, multiple recesses are formed in the manner of parallel grooves or flutes, disposed side by side, to create a fluted plate surface. Due to the multiplicity of recesses, heat is removed from the heated fluid at many points through the plate body, in the direction of the chamber side of the combined filter plate.

In accordance with another feature of the invention, the flute-type recesses formed as grooves on the membrane side of the combined filter plate extend in a horizontal direction.

In accordance with a further feature of the invention, additional fluting is provided on the chamber side, extending in a vertical direction, to form distribution channels on the chamber side of the combined filter plate, that is in the plate surface facing away from the membrane. The thickness of the plate body wall is, of course, also decreased by the formation of distribution channels, so that the distribution channels formed in the plate also favor the transfer of heat from the fluid to the chamber side.

In accordance with a concomitant feature of the invention, the distribution channels have a discharge port and/or a feed port.

A further advantage of the invention resides in successfully maintaining the traditional structure of a filter plate, in other words improving the heatability of the filter plate without fundamentally altering its construction.

Other features which are considered as characteristic for the invention are set forth in the appended claims.

Although the invention is illustrated and described herein as embodied in a heatable and coolable filter plate, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, plan view of a membrane side of a combined chamber and membrane filter plate according to the invention;

FIG. 2 is an enlarged, cross-sectional view, taken along a line II-II of FIG. 1, of two filter plates according to FIG. 1 disposed side by side in a filter packet;

FIG. 3 is a plan view of a chamber side of a combined chamber and membrane filter plate with vertical distribution channels according to the invention; and

FIG. 4 is a cross-sectional view taken along a line IV-IV of FIG. 3.

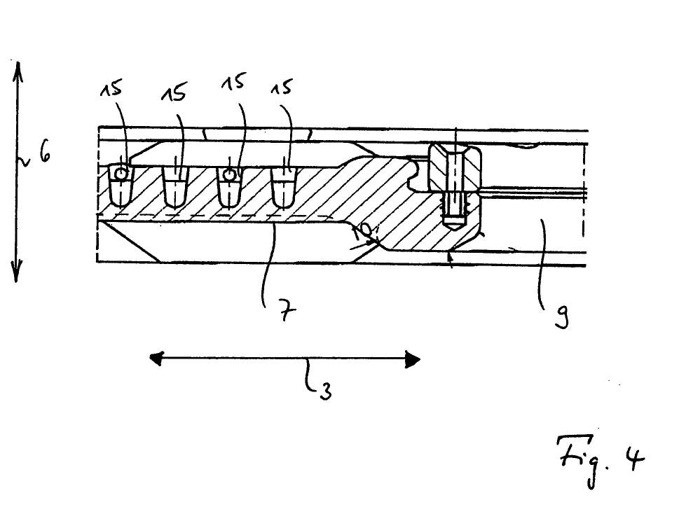

### DETAILED DESCRIPTION OF THE INVENTION

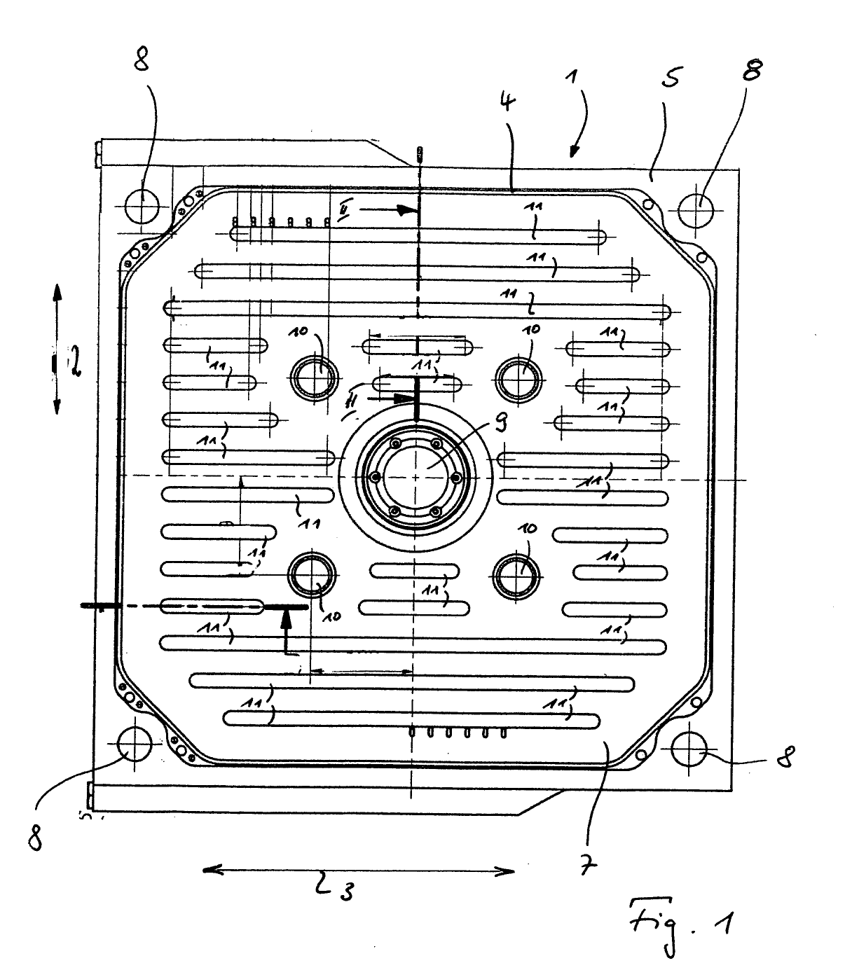

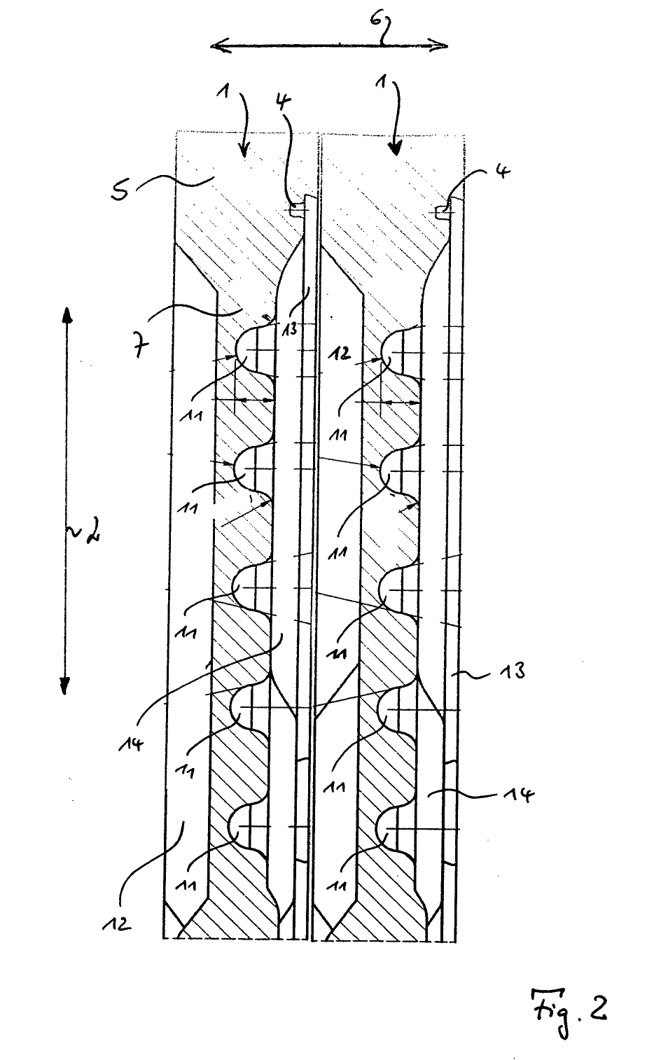

Referring now to the figures of the drawings in detail and first, particularly, to FIG. 1 thereof, there is seen a combined chamber and membrane filter plate 1 which is substantially square and therefore has approximately identical dimensions in a vertical direction 2 and in a horizontal direction 3. The side of the combined chamber and membrane filter plate 1 shown in FIG. 1 has an attachment groove 4 around its perimeter for attachment of a membrane 13, which is not shown in FIG. 1. The attachment groove 4 extends along a plate edge 5 that borders the chamber and membrane filter plate 1. The plate edge 5 is thicker in the transverse direction 6, which extends perpendicular to both the vertical direction 2 and the horizontal direction 3, than a plate body 7 that is bordered by the plate edge 5. This is especially easily and clearly visible in FIG. 2. In each of the four corner areas, the combined chamber and membrane filter plate 1 is equipped with a discharge borehole 8. A filtrate feed borehole 9 is provided centrally, at the center of the combined chamber and membrane filter plate 1. The combined chamber and membrane filter plate 1 also has support cams 10 on its plate body 7 to support the plate body 7 against a plate body 7 of a respectively adjacent filter plate 1.

Flute-type recesses configured as grooves 11 extending in the horizontal direction 3 are shown in FIG. 1. It is also apparent in FIG. 1 that the individual grooves 11 have different lengths in the horizontal direction 3. The horizontal lengths of the grooves 11 can therefore be adjusted in each case to the particular conditions of the combined chamber and membrane filter plate 1. Thus the grooves 11 are shortened in the horizontal direction 3 in the region of the support cams 10 or in the region of the filtrate feed borehole 9, in such a way that a collision of the components will not occur. Finally, the lengths of the grooves 11 are also dimensioned in such a way that the stability of the plate body 7 is not impaired.

The mode of functioning of the invention is described with reference to the illustration in FIG. 2. In FIG. 2, two combined chamber and membrane filter plates 1 are disposed side by side in the transverse direction 6 to form a filter packet. The two filter plates 1 form a closed filter chamber 12 therebetween. The filter chamber 12 is divided in two by the membrane 13, which is fastened in the attachment groove 4.

The membrane 13 thus subdivides the space formed between the filter plates 1 into the actual filter chamber 12 and a membrane chamber 14, which lies behind the membrane 13. In other words, due to the combined structure of the chamber and membrane filter plate 1, in the exemplary embodiment, the filter chamber 12 is always situated on the left side in the filter plate 1, while the membrane chamber 14 is created on the right side, in each case shielded by the membrane 13. It can also be seen that in each case the membrane chamber 14 opens up toward the rear into the grooves 11. The heated fluid is introduced into the membrane chamber 14 through a channel that is not shown in FIG. 1. The heated fluid then fills both the membrane chamber 14 and the grooves 11. The heat from the fluid is transferred from the membrane chamber 14 through the membrane 13 into the filter chamber 12, which is disposed adjacent the membrane 13 in the transverse direction 6. The heat from the fluid also travels from the grooves 11 through the plate body 7 into the filter chamber 12, which is adjacent the grooves 11 in the transverse direction 6. From the illustration in FIG. 2 it is clearly recognizable that the wall of the plate body 7 is much narrower in the area of the grooves 11, as viewed in the transverse direction, than in the remaining areas. Due to this narrower wall thickness in the transverse direction 6, the heat from the fluid can be directed much more effectively through the plate body 7 into the filter chamber 12 that lies adjacent it in the transverse direction 6.

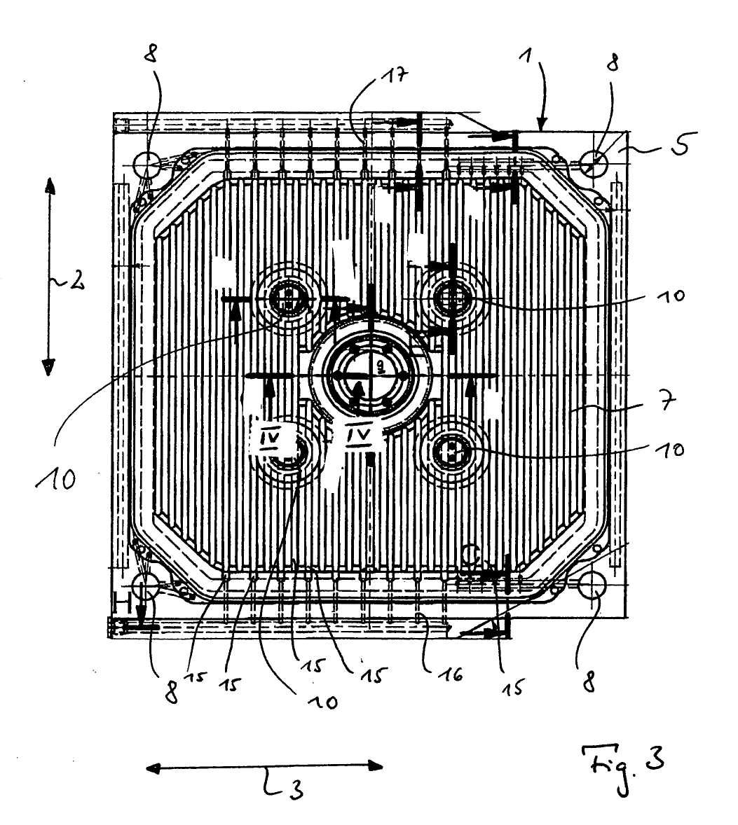

FIG. 3 shows a plan view of the chamber side of a special embodiment of the combined chamber and membrane filter plate 1 of the invention. In this case as well, the plate edge 5 projects beyond the plate body 7 in the transverse direction 6. In FIG. 3, a multiplicity of distribution channels 15 extending in the vertical direction 2 are formed in the plate body 7. The distribution channels 15 can be equipped with feed ports 17 on the upper side of the plate and/or discharge ports 16 on the underside of the plate.

According to the invention, the distribution channels 15 on the chamber side of the combined chamber and membrane filter plate 1 can also assume the function of the recesses with respect to temperature transfer through the plate body 7. It is also possible to structure the combined chamber and membrane filter plate in such a way that the surface of the plate body on the side that faces the membrane 13 is smooth, and has depressions in the form of distribution channels 15 only on the chamber side that faces away from the membrane 13. It is also possible according to FIG. 1 for grooves 11 to be provided on the side allocated to the membrane 13, while the surface of the body 7 that faces away from the membrane 13 is smooth. A combined form is also possible, with grooves 11 on the membrane side and distribution channels 15 on the chamber side of the combined chamber and membrane filter plate 1.

1. A combined chamber and membrane filter plate, the combined chamber and membrane filter plate comprising:
a plate body;
a plate edge being thicker than said plate body, projecting beyond said plate body and framing said plate body;
a chamber side configured to form a filter chamber; and
a membrane side having a membrane adapted to and spaced from said plate body;
said plate body having a plate surface facing said membrane and a multiplicity of parallel recesses implemented as grooves in said plate surface, said grooves decreasing a thickness of said plate body and configured to form a fluted plate surface.

2. The chamber and membrane filter plate according to claim 1, wherein said grooves extend in a horizontal direction.

3. The chamber and membrane filter plate according to claim 1, wherein said plate body has a plate surface facing away from said membrane and recesses implemented as distribution channels in said plate surface facing away from said membrane.

4. The chamber and membrane filter plate according to claim 3, wherein said distribution channels extend in a vertical direction.

5. The chamber and membrane filter plate according to claim 3, wherein said distribution channels have at least one of a discharge port or a feed port.
